(19) United States
(12) Patent Application Publication
(10) Pub. No.: US 2003/0126757 A1
(43) Pub. Date: Jul. 10, 2003

(54) Tool guide assembly employing standard tape measure

(76) Inventors: Robert Farney, Huntington Beach, CA (US); John Bissell, Mission Viejo, CA (US)

Correspondence Address: LARSON & TAYLOR, PLC, 1199 NORTH FAIRFAX STREET, SUITE 900, ALEXANDRIA, VA, 22314, US

(21) Appl. No.: 10/329,435

(22) Filed: Dec. 27, 2002

Related U.S. Application Data
(60) Provisional application No. 60/345,544, filed on Jan. 7, 2002.

(51) Int. Cl. G01B 3/10

(52) U.S. Cl. 33/770

(57) ABSTRACT

A guide tool assembly is provided for use with a tape measuring device to measure, scribe or cut drywall or the like. The guide tool assembly consists of two parts, one a slidable guide element including a mounting slot for enabling the slidable guide element to be slidably mounted on the measuring tape of the tape measuring device and a knife guide element adapted to be affixed to the measuring tape at the free end thereof. The knife guide includes a transverse opening therein for, in one application, receiving a cutting blade. In this application, the slidable element is set at the desired measuring point along the tape and with the slidable element in engagement with the edge of the drywall panel to be cut, the slidable element and the cutting blade are moved in parallel to provide a cut of the desired width. In an alternative embodiment, the assembly is used for making arcuate cuts or inscriptions.

### PRIORITY CLAIM OF EARLIER FILED APPLICATION

The present application claims priority of Provisional Application Serial No. 60/345,544 filed on Jan. 7, 2002.

### FIELD OF THE INVENTION

The present invention relates to tools for measuring, cutting and scribing drywall and the like and, more particularly, an improved tool guide assembly for these purposes.

### BACKGROUND OF THE INVENTION

A number of different tools have been developed for measuring, cutting and scribing gypsum, plaster and other relatively soft materials. Conventionally, a tape measure and a pencil or other scribing instrument are first used to measure off and mark the limits of a cut to be made and a cutting tool (e.g., a tool mounted razor blade or the like) is then used to make the cut. This operation can be cumbersome and time consuming particularly when a large number of cuts is to be made.

### SUMMARY OF THE INVENTION

In accordance with the invention, a tool guide assembly is provided which enables measuring and cutting and/or scribing materials such as drywall, dryvit board, rigid insulation, acoustical tile, cement board, plywood paneling, sheet goods and the like. Moreover, the materials can be in rectangular, circular and other shapes. As explained below, the tool guide assembly includes two parts which are preferably molded of plastic and are affixed to a standard retractable tape measure so as to enable a user to measure and cut/scribe a predetermined sized piece of material in one step. The assembly can also be used for cutting/scribing arcuate “indentations” (i.e., cuts or inscriptions) of a predetermined radius.

In accordance with one aspect of the invention, there is provided a guide tool assembly for use with a tape measuring device including a retractable measuring tape having a free end, the guide tool assembly comprising:

a slidable guide element including mounting means for enabling the slidable guide element to be slidably mounted on the measuring tape of the tape measuring device for sliding movement therealong; and

a knife guide element adapted to be affixed to the tape measure at the free end thereof, said knife guide including a transverse opening therein for, in use, receiving a cutting blade.

Preferably, the mounting means comprises a laterally opening slot in the slidable guide element. In a preferred implementation, the slidable guide element includes a body portion and a resilient arm portion connected at one end thereof to said body portion so as to form said slot between said arm portion and said body portion. Advantageously, the slot is substantially arcuate. The slot is preferably sized such as to prevent passage therethrough of an angled end portion of said measuring tape.

Preferably, the slidable guide element includes tool holding means for holding a further tool. In one implementation, the tool holding means comprises means for holding a scribing tool. Advantageously, the tool holding means comprises a laterally outwardly extending, U-shaped portion forming a recess in which the further tool is held.

The measuring tape conventionally includes an angled end portion at the free end thereof and, in a preferred embodiment, the opening in the knife guide element includes oppositely directed, inwardly projecting members at opposite lateral ends thereof forming a first aperture for receiving said angled end portion of said measuring tape and a second aperture for receiving the cutting blade.

In accordance with a further aspect of the invention, there is provided a method for guiding the cutting of a material suitable for such cutting using a measuring tape having a free end at which graduated measurement markings begin and a cutting knife capable of cutting the material, the method comprising:

mounting a slidable guide element on the measuring tape for sliding movement therealong;

mounting a knife guide element at the free end of the measuring tape;

sliding the guide element to a position along the measuring tape corresponding to a desired width of the cut to be made relative to an adjacent edge of the material to be cut; placing the guide element against said adjacent edge so that the free end of the tape is spaced from the adjacent edge by a distance corresponding to the desired width of the cut to be made;

inserting a cutting blade into said knife guide; and

while holding the slidable guide element at said position and in engagement with said adjacent edge, moving said slidable guide element and said cutting blade in said knife guide element in parallel so as to produce a cut of said desired width.

As indicated above, a standard measuring tape conventionally has an angled portion at said free end thereof and, in a preferred embodiment, the knife guide is mounted on said angled portion.

In accordance with yet another aspect of the invention, there is provided a method for providing an arcuate indentation of a desired radius in a flat surface of a member of a material suitable for such indentation using a measuring tape having a free end at which graduated measurement markings begin and a tool capable of providing indentation of said material, the method comprising:

mounting a slidable guide element on the tape measure for sliding movement therealong;

fixedly mounting a further element at the free end of the measurement tape;

sliding the slidable guide element to a position along the tape corresponding to the desired radius of the arcuate indentation;

mounting the tool on the slidable element; and

while maintaining the further element as a pivot point on the surface of the member, causing the tool on the sliding element to swing through an arc around said pivot point while being pressed into engagement with said surface so as to provide an arcuate indentation in the surface.

In one implementation, the tool comprises a scribing tool and the indentation is an arcuate inscription in the surface of the member. In an alternative implementation, the tool comprises a cutting tool and the indentation is an arcuate cut in the member.

Further features and advantages of the present invention will be set forth in, or apparent from, the detailed description of preferred embodiments thereof which follows.

### BRIEF DESCRIPTION OF THE DRAWINGS

FIG. 1 is a side elevational view of a slidable guide element constructed in accordance with a preferred embodiment of the invention;

FIG. 2 is a side elevational view, from the opposite side, of the slidable guide element of FIG. 1;

FIG. 3 is a top plan view of the slidable guide element of FIG. 1;

FIG. 4 is a bottom plan view of the slidable guide element of FIG. 1;

FIG. 5 is a top plan view of a fixed (knife) guide element constructed in accordance with a preferred embodiment of the invention;

FIG. 6 is a side elevational view of the slidable guide element of FIG. 5;

FIG. 7 is a top plan view of the slidable and fixed guide elements of FIGS. 1 and 5 mounted on a measuring tape or tape blade;

FIG. 8 is a top plan view showing one application of the tool guide assembly of the invention; and

FIG. 9 is a top plan view showing a further application of the tool guide assembly of the invention.

### DESCRIPTION OF THE PREFERRED EMBODIMENTS

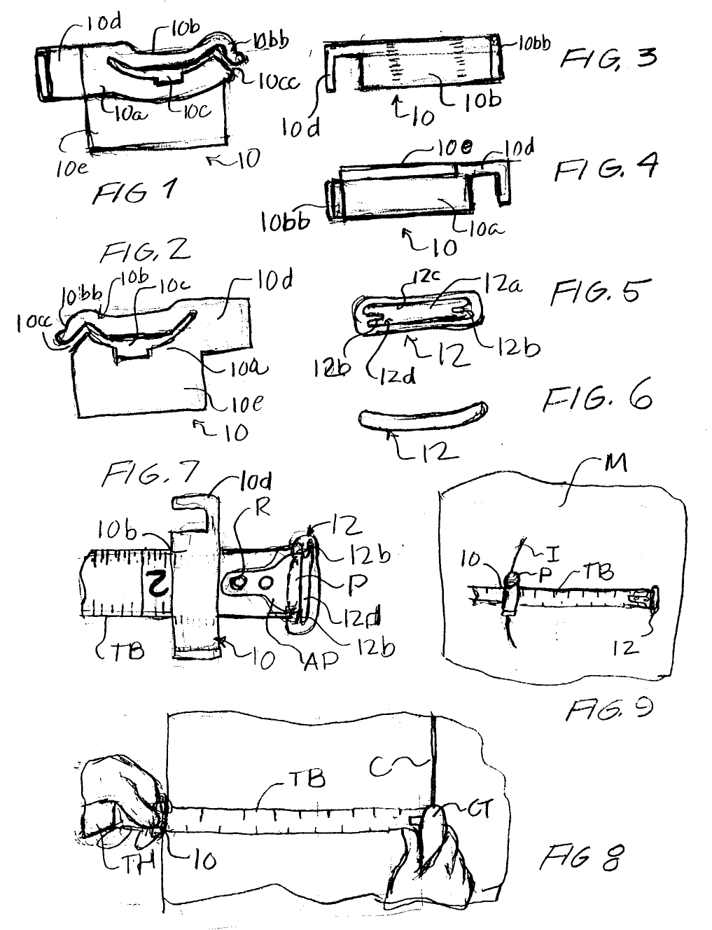

As indicated above, the tool guide assembly of the invention consists of two parts, a slidable element, denoted 10 in the drawings, and a fixed element denoted 12 in the drawings. Referring to FIGS. 1-4, a preferred embodiment of the slidable element or slidable tape blade guide 10 is shown. As illustrated, the slidable element 10 includes a main body portion 10a and an arm portion 10b extending outwardly from one side of main body portion 10a to form a slot 10c therebetween. Element 10 is preferably molded of plastic and arm portion 10b is somewhat resilient or flexible so as to permit limited flexing thereof. As illustrated, slot 10c is generally arcuate in shape with a flattened upper mid-portion and includes a further curved portion 10cc at the open end thereof formed by a lip portion 10bb of arm 10b. Slot 10c is adapted to receive a tape blade or measuring tape therein as discussed below.

Element 10 further comprises a generally U-shaped tool holder 10d best seen in FIGS. 3 and 4. Tool holder 10d extends outwardly from body portion 10a on the opposite side thereof from the open end of slot 10c and is adapted for receiving therein a pencil or other scribing tool, or a razor blade or other cutting tool. It will be appreciated that tool holding portion 10d can take other forms and, for example, in an alternative embodiment, can comprise a pair of outwardly extending spaced fingers between which such a cutting/scribing tool is received.

Element 10 also includes a downwardly projecting support or steadying portion 10e which extends downwardly from main body portion 10a. In one application of the invention, which is depicted in FIG. 8 and described below, support portion 10e is brought into engagement with a lateral edge of a member to be cut.

Referring to FIGS. 5 and 6, there is shown a preferred embodiment of the fixed element or knife guide 12. As shown in FIG. 5, element 12 includes an elongate central opening 12a therein. First and second oppositely disposed, inwardly projecting members or parts 12b partially divide the central opening 12a into two separate areas 12d and 12c which function as first and second apertures as explained below.

Referring to FIG. 7, the free end of a standard measuring tape or tape blade TB is shown. As is conventional, tape blade TB has affixed thereto, by rivets R, an angle portion AP including a part P, indicated in dashed lines and projecting downwardly, i.e., into the drawing sheet as viewed in FIG. 7, at a right angle to tape blade TB. Tape blade TB is received in slot 10c in slidable element 10 as indicated above. In the preferred implementation under consideration, slidable element 10 is of the particular configuration illustrated and is molded in such a manner as to permit the tape measuring blade TB, while slightly bent, to be inserted into the middle section of slot 10c, and such that, when the blade TB is released, the blade TB is prevented from exiting, while guide element 10 is still permitted to slide freely up and down along measuring blade TB without restriction.

Fixed guide element 12 is attached to the free end of tape blade and, in particular, the right angle projecting portion P of angled portion AP of tape blade TB is received in aperture 12c of element 12 so that companion aperture 12d is exposed, as illustrated, and is thus adapted to receive a cutting blade (not shown), as described below in connection with FIG. 8. It is noted that while the configuration of element 12 illustrated in FIGS. 5 and 6 is much preferred because, inter alia, of the simplicity thereof, other configurations may be used to both affix the element 12 to the tape blade TB and to provide a mounting site for a cutting blade or the like.

Referring to FIG. 8, a first important application of the guide tool of the invention is illustrated. In this application, which is a cutting application, a cut is to be made in a member M at a desired distance from the edge E thereof. As indicated above, the member M to be cut can be drywall, dryvit board, rigid insulating acoustical tile, cement board, plywood panel paneling, sheet goods or the like.

In the application depicted in FIG. 8, slidable element 12 is moved along measuring tape or tape blade TB to a measuring position along tape blade TB corresponding to the width of the cut to be made relative to edge E. Further, with fixed guide element 12 mounted on the free end of the blade TB as described above in connection with FIG. 7, the blade of a knife or cutting tool CT is inserted into an exposed aperture of guide element 12 corresponding to aperture 12d of FIG. 7 so as to be supported by guide element 12.

Next, with the measuring tape housing (a portion of which is shown at TH) held in one hand and the slidable element 10 gripped by that hand and positioned at the desired measuring length or point along tape blade TB with support portion 10e bearing against the edge E of member M, and cutting tool CT, as mounted in guide element 12, inserted into member M, guide element 10 and cutting tool CT are moved in parallel so that latter provides straight cut, indicated at C. It will be appreciated that guide element 10 acts as paralleling guide while pressed against the edge E of member M and also functions to protect the hand or fingers from friction burn, abrasion or the like during the cutting process.

Referring to FIG. 9, a further application of the guide tool assembly of the invention is illustrated. As indicated above, tool receiving portion 10d of guide element 10 is adapted to receive, as a snap fit, a further tool such as, for example a lead scribing insert or a razor blade insert so as to enable a user to scribe or cut a radius into a material or member M. In accordance with one embodiment, a pencil P is shown in FIG. 9 as being so mounted on guide element 10. Guide element 12 is mounted on the free end of tape blade TB as described above, and, in this application, the slidable guide element 10 is moved to the desired radius measurement point (e.g., to the 10 inch mark where a 10 inch radius is desired) and, with guide element 12 acting as a fixed pivot point, guide element 10 is pulled across the material M by the user while the user simultaneously presses down on the pencil (or, alternatively a razor insert) so as to scribe (or cut into) an arcuate inscription I (or cut) of the desired radius into the surface of the material M.

Although the invention has been described above in relation to preferred embodiments thereof, it will be understood by those skilled in the art that variations and modifications can be effected in these preferred embodiments without departing from the scope and spirit of the invention.

What is claimed:

1. A guide tool assembly for use with a tape measuring device including a retractable measuring tape having a free end, said guide tool assembly comprising:
a slidable guide element including mounting means for enabling the slidable guide element to be slidably mounted on the measuring tape of the tape measuring device for sliding movement therealong; and
a knife guide element adapted to be affixed to the measuring tape at the free end thereof, said knife guide including a transverse opening therein for, in use, receiving a cutting blade.

2. A tool guide assembly as claimed in claim 1 wherein said mounting means comprises a laterally opening slot in said slidable guide element.

3. A tool guide assembly as claimed in claim 2 wherein said slidable guide element includes a body portion and a resilient arm portion connected at one end thereof to said body portion so as to form said slot between said arm portion and said body portion.

4. A tool guide assembly as claimed in claim 3 wherein said slot is substantially arcuate.

5. A tool guide assembly as claimed in claim 3 wherein said slot is sized such as to prevent passage therethrough of an angled end portion of said measuring tape.

6. tool guide assembly as claimed in claim 1 wherein said slidable guide element includes tool holding means for holding a further tool.

7. A tool guide assembly as claimed in claim 6 wherein said tool holding means comprises means for holding a scribing tool.

8. A tool guide assembly as claimed in claim 6 wherein said tool holding means comprises a laterally outwardly extending, U-shaped portion forming a recess in which the further tool is held.

9. A tool guide assembly as claimed in claim 1 wherein the measuring tape includes an angled end portion at the free end thereof and said opening in said knife guide element includes oppositely directed, inwardly projecting members at opposite lateral ends thereof forming a first aperture for receiving said angled end portion of said measuring tape and a second aperture for receiving the cutting blade.

10. A method for guiding the cutting of a material suitable for such cutting using a measuring tape having a free end at which graduated measurement markings begin and a cutting knife capable of cutting the material, said method comprising:
mounting a slidable guide element on the measuring tape for sliding movement therealong;
mounting a knife guide element at the free end of the measuring tape;
sliding the guide element to a position along the measuring tape corresponding to a desired width of the cut to be made relative to an adjacent edge of the material to be cut; placing the guide element against said adjacent edge so that the free end of the tape is spaced from the adjacent edge by a distance corresponding to the desired width of the cut to be made;
inserting a cutting blade into said knife guide; and
while holding the slidable guide element at said position and in engagement with said adjacent edge, moving said slidable guide element and said cutting blade in said knife guide element in parallel so as to produce a cut of said desired width.

11. A method as claimed in claim 1 wherein said measuring tape has an angled portion at said free end thereof and said knife guide is mounted on said angled portion.

12. A method for providing an arcuate indentation of a desired radius in a flat surface of a member of a material suitable for such indentation using a measuring tape having a free end at which graduated measurement markings begin and a tool capable of providing indentation of said material, said method comprising:
mounting a slidable guide element on the tape measure for sliding movement therealong;
fixedly mounting a further element at the free end of the measurement tape;
sliding the guide element to a position along the tape corresponding to the desired radius of the arcuate indentation;
mounting the tool on the sliding element; and
while maintaining the further element as a pivot point on the surface of the member, causing the tool on the sliding element to swing through an arc around said pivot point while being pressed into engagement with said surface so as to provide an arcuate indentation in the surface.

13. A method as claimed in claim 12 wherein said tool comprises a scribing tool and the indentation is an arcuate inscription in the surface of the member.

14. A method as claimed in claim 12 wherein said tool comprises a cutting tool and the indentation is an arcuate cut in the member.
